(19) United States
(12) Patent Application Publication
(10) Pub. No.: US 2007/0174483 A1
(43) Pub. Date: Jul. 26, 2007

(54) Methods and apparatus for implementing protection for multicast services

(76) Inventors: Alex E. Raj, Westford, MA (US); Robert H. Thomas, Lexington, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/336,457

(22) Filed: Jan. 20, 2006

(51) Int. Cl. G06F 15/173

(52) U.S. Cl. 709/238

(57) ABSTRACT

A router in a label-switching network sets up one or more backup paths to forward multicast data traffic in the event of a failure. Network failures include link failures and node failures. If a link failure occurs, a given router in a respective label-switching network can forward multicast data traffic on a first backup path to a next hop downstream router that it normally sends the multicast data traffic. If the next hop downstream router fails, the given router can circumvent sending the multicast data traffic to the next hop downstream router and instead send the multicast data traffic on respective backup paths to the set of routers (e.g., next next hop downstream routers) that the next hop downstream router (e.g., the failing router) normally would forward the multicast data traffic in the absence of the network failure.

### BACKGROUND

As well known, the Internet is a massive network of networks in which computers communicate with each other via use of different communication protocols. The Internet includes packet-routing devices, such as switches, routers and the like, interconnecting many computers. To support routing of information such as packets, each of the packet-routing devices typically maintains routing tables to perform routing decisions in which to forward traffic from a source computer, through the network, to a destination computer.

One way of forwarding information through a provider network over the Internet is based on MPLS (Multiprotocol Label Switching) techniques. In an MPLS-network, incoming packets are assigned a label by a so-called LER (Label Edge Router) receiving the incoming packets. The packets in the MPLS network are forwarded along a predefined Label Switch Path (LSP) defined in the MPLS network based, at least initially, on the label provided by a respective LER. At internal nodes of the MPLS-network, the packets are forwarded along a predefined LSP through so-called Label Switch Routers. LDP (Label Distribution Protocol) is used to distribute appropriate labels for label-switching purposes.

Each Label Switching Router (LSR) in an LSP between respective LERs in an MPLS-type network makes forwarding decisions based solely on a label of a corresponding packet. Depending on the circumstances, a packet may need to travel through many LSRs along a respective path between LERs of the MPLS-network. As a packet travels through a label-switching network, each LSR along an LSP strips off an existing label associated with a given packet and applies a new label to the given packet prior to forwarding to the next LSR in the LSP. The new label informs the next router in the path how to further forward the packet to a downstream node in the MPLS network eventually to a downstream LER that can properly forward the packet to a destination.

MPLS service providers have been using unicast technology to enable communication between a single sender and a single receiver in label-switching networks. The term unicast exists in contradistinction to multicast, which involves communication between a single sender and multiple receivers. Both of such communication techniques (e.g., unicast and multicast) are supported by Internet Protocol version 4 (Ipv4).

Service providers have been using so-called unicast Fast Reroute (FRR) techniques for quite some time to provide more robust unicast communications. In general, fast rerouting includes setting up a backup path for transmitting data in the event of a network failure so that a respective user continues to receive data even though the failure occurs.

### SUMMARY

Conventional mechanisms such as those explained above suffer from a variety of shortcomings. For example, fast reroute techniques have not yet been significantly developed for multicast traffic because multicasting is more complex than unicast communications and does not easily lend itself to fast rerouting. Accordingly, service providers currently do not implement robust backup techniques. The occurrence of a respective link or node failure in a label-switching network thus can prevent respective users from properly receiving multicast data traffic.

In contradistinction to the techniques discussed above as well as additional techniques known in the prior art, embodiments discussed herein include novel techniques associated with multicasting. For example, embodiments herein are directed to a multicast FRR procedure that uses a NHOP (Next Hop) tunnel (e.g., an LDP backup path) for link protection purposes and NNHOP (Next Next Hop) tunnel (e.g., an LDP backup path avoiding a failing node) for purposes of node protection. In other words, a router in a label-switching network sets up one or more backup paths to forward multicast data traffic in the event of a failure.

Network failures include link failures and node failures. If a link failure occurs, a given router in a respective label-switching network can forward multicast data traffic on a first backup path to a next hop downstream router that it normally sends the multicast data traffic. Forwarding on the first backup path avoids the failed link. If the next hop downstream router happens to fail, the given router can circumvent sending the multicast data traffic to the next hop downstream router and instead send the multicast data traffic on respective one or more backup paths to a respective set of one or more routers (e.g., next next hop downstream routers) that the next hop downstream router normally would forward the multicast data traffic in the absence of the network failure. Accordingly, forwarding on the one or more backup paths circumvents the failing node.

More specifically, in one embodiment, a given router (e.g., a root router or upstream router) in a label-switching network forwards multicast data traffic through other downstream routers to more than one host recipient destinations during normal operations in the absence of a network failure. The given router establishes one or more backup paths on which to forward the multicast data traffic in the event of a network failure. For example, the upstream router can set up a backup or alternate path (e.g., a tunnel) to a next hop downstream that normally receives the multicast data traffic on a primary path set up for such purposes.

If a communication link failure occurs on a primary path (e.g., communication link as opposed to node) normally used to forward the multicast data traffic to the next hop downstream router, then the given router can forward the multicast data traffic on the backup path to the next hop downstream router.

In one embodiment, when transmitting the multicast data traffic on such a backup path, the given router appends an extra label to the multicast data traffic forwarded on the backup path. The extra label can be used to facilitate routing of the multicast data traffic on the backup path.

In a fturther embodiment, the backup path (e.g., tunnel) can strip the extra label off the multicast data traffic prior to reaching the next hop downstream router so that the next hop downstream router receives the same packet formatting that would have been otherwise been received on the primary path if the failure did not occur.

Since the multicast data traffic sent from the given router can be received on an interface associated with the backup path in lieu on an interface associated with the primary path, RPF (Reverse Path Forwarding) checking is disabled at the next hop downstream router according to one embodiment. Instead of RPF checking, the next hop downstream router receiving the multicast data traffic checks the corresponding label to identify whether such data should be received at the next hop router. The label-checking at the next hop router can include checking whether the label is normally used to route corresponding data payloads through the next hop router to yet other downstream routers. Accordingly, the next hop downstream router receiving the multicast data traffic (and proper label) from either the primary path or backup path need only change the label of incoming multicast data traffic and forward the multicast data traffic to yet other downstream routers toward the appropriate destinations without implementing more complex conventional RPF checking routines.

Note that other embodiments herein also anticipate failures with respect to a next hop downstream router to which the given router forwards the multicast data traffic. For example, a given router can set up a downstream path circumventing a corresponding next hop downstream router. In such an embodiment, the given router learns of successive set of one or more nodes (e.g., next next hop downstream routers) and corresponding labels that the next hop downstream router normally uses to forward the multicast data traffic received from the given router. Thus, in addition to (or in lieu of) the backup path discussed above, the given router sets up backup paths to each router in the set of next next hop downstream routers around the next hop downstream router.

In the event that a network failure (e.g., a link failure or node failure in the next hop router), the given router can append the appropriate label (to the multicast data traffic) that the next hop downstream router would have appended to the multicast data traffic in lieu of appending the label that would be used if given router forwarded the multicast data traffic on the primary path if there were no failure.

Similar to the backup path techniques as discussed above, the given router can append a second label to the multicast data traffic for purposes of forwarding the multicast data traffic over the backup paths circumventing the next hop downstream router. Each of the backup paths (e.g., tunnels), which are used to circumvent the failing next hop downstream router, can strip the extra label off the multicast data traffic prior to reaching the next next hop downstream router so that the next next hop downstream router receives the same packet formatting that would have been otherwise been received from the next hop downstream router if the failure did not occur at the next hop downstream router.

Since the multicast data traffic can be received on an interface associated with the backup path at the next next hop downstream router, according to one embodiment, RPF checking is disabled at the next next hop downstream router. For example, instead of RPF checking, the next next hop downstream routers receiving the multicast data traffic checks the corresponding label to identify whether such multicast data traffic should be received at the respective next next hop downstream router for forwarding on to yet other downstream routers or hosts.

The multicast techniques in this disclosure can be used to extend the unicast FRR backup path procedure as discussed in U.S. patent application Ser. No. 11/203,801 (Attorney docket number CIS05-31), the entire teachings of which are incorporated herein by reference, to include multicast FRR backup path tunnels along with other techniques germane to multicast FRR.

Note that techniques herein are well suited for use in applications such as label-switching network that support routing of multicast data traffic. However, it should be noted that configurations herein are not limited to use in such applications and thus configurations herein and deviations thereof are well suited for other applications as well.

In addition to the techniques discussed above, example embodiments herein also include a computerized device (e.g., a data communication device) configured to enhance multicasting technology and related services. According to such embodiments, the computerized device includes a memory system, a processor (e.g., a processing device), and an interconnect. The interconnect supports communications among the processor, and the memory system. The memory system is encoded with an application that, when executed on the processor, produces a process to enhance multicasting technology and provide related services as discussed herein.

Yet other embodiments of the present application disclosed herein include software programs to perform the method embodiment and operations summarized above and disclosed in detail below under the heading Detailed Description. More particularly, a computer program product (e.g., a computer-readable medium) including computer program logic encoded thereon may be executed on a computerized device to enhance multicasting technology and related services as further explained herein. The computer program logic, when executed on at least one processor with a computing system, causes the processor to perform the operations (e.g., the methods) indicated herein as embodiments of the present application. Such arrangements of the present application are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein.

One particular embodiment of the present application is directed to a computer program product that includes a computer readable medium having instructions stored thereon to enhance multicasting technology and support related services. The instructions, when carried out by a processor of a respective first router (e.g., a computer device), cause the processor to perform the steps of: i) configuring the network to include at least one backup path with respect to a primary network path that supports multicast label switching of multicast data traffic; ii) transmitting the multicast data traffic from a first router over the primary network path to a second router; and iii) in response to detecting a failure in the network, initiating transmission of the multicast data traffic over the at least one backup path in lieu of transmitting the multicast data traffic over the primary network path. Other embodiments of the present application include software programs to perform any of the method embodiment steps and operations summarized above and disclosed in detail below.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Cisco Systems, Inc. of San Jose, Calif.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a label-switching network that supports transmission of multicast data traffic on a backup path according to an embodiment herein.

FIG. 2 is a diagram of a label-switching network that supports transmission of multicast data traffic on backup paths according to an embodiment herein.

FIG. 3 is a block diagram of a processing device suitable for executing fast rerouting of multicast data traffic according to an embodiment herein.

FIG. 4 is a flowchart illustrating a general technique for supporting fast rerouting of multicast data traffic according to an embodiment herein.

FIG. 5 is a flowchart illustrating a more specific technique for supporting fast rerouting of multicast data traffic according to an embodiment herein.

FIG. 6 is a flowchart illustrating a more specific technique for supporting fast rerouting of multicast data traffic according to an embodiment herein.

FIG. 7 is a flowchart illustrating a more specific technique for supporting fast rerouting of multicast data traffic according to an embodiment herein.

FIG. 8 is a diagram of a label-switching network illustrating forwarding techniques according to an embodiment herein.

FIG. 9 is a diagram of a label-switching network illustrating forwarding techniques according to an embodiment herein.

FIG. 10 is a diagram of a label-switching network illustrating forwarding techniques according to an embodiment herein.

FIG. 11 is a diagram of a data structure according to an embodiment herein.

FIG. 12 is a diagram of a data structure according to an embodiment herein.

### DETAILED DESCRIPTION

According to embodiments herein, a given router in a label-switching network sets up one or more backup paths to forward multicast data traffic in the event of a failure. Network failures include link failures and node failures. If a link failure occurs, the given router in the respective label-switching network forwards multicast data traffic on a first backup path (instead of a primary path) to a next hop downstream router that it normally sends the multicast data traffic. If the next hop downstream router fails, the given router can circumvent sending the multicast data traffic to the next hop downstream router and instead send the multicast data traffic on respective backup paths to a set of one or more routers (e.g., next next hop downstream routers) that the next hop downstream router (e.g., the failing router) normally would forward the multicast data traffic in the absence of the network failure.

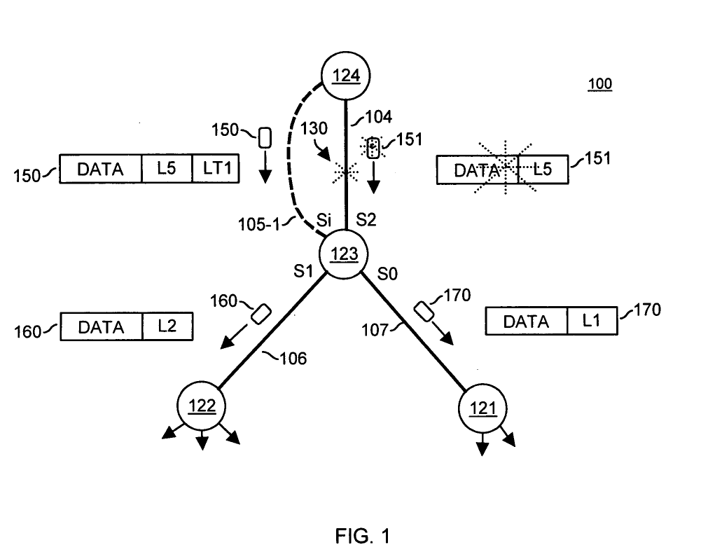

FIG. 1 is a diagram of a network 100 (e.g., a communication system such as a label-switching network) in which data communication devices such as routers support point-to-multipoint communications according to an embodiment herein. Note that the term “router” herein refers to any type of data communication device that supports forwarding of data in a network. Routers can be configured to originate data, receive data, forward data, etc. to other nodes or links in network 100.

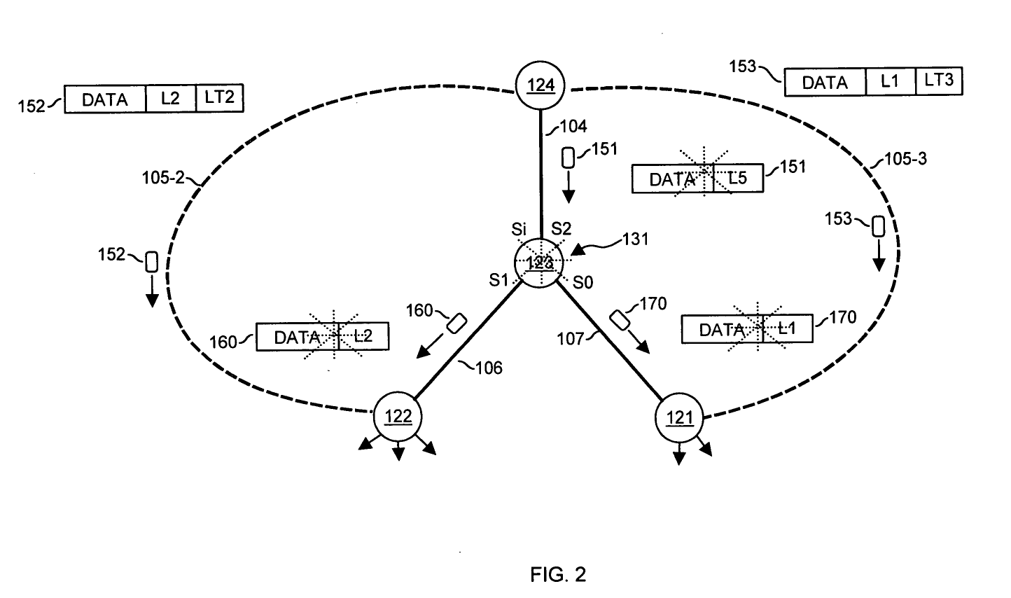

As shown, network 100 (e.g., a label-switching network) such as that based on MPLS (Multi-Protocol Label Switching) includes router 124, router 123, router 122, and router 121 for forwarding multicast data traffic (and potentially unicast data as well if so configured) over respective communication links such as primary network path 104, communication link 106, and communication link 107. Router 122 and router 121 can deliver data traffic directly to host destinations or other routers in a respective service provider network towards a respective destination node. Note that network 100 can include many more routers and links than as shown in example embodiments of FIGS. 1 and 2.

In one embodiment, unicast and multicast communications transmitted through network 100 are sent as serial streams of data packets. The data packets are routed via use of label-switching techniques. For example, network 100 can be configured to support label-switching of multicast data traffic from router 124 (e.g., a root router) to respective downstream destination nodes.

During normal operations, router 124 creates and forwards label-switching data packets including multicast data traffic over primary network path 104. As an example shown in FIG. 1, in the absence of link failure 130, router 124 generates data packet 151 to include label L5 for transmitting the data packet 151 (and the like) over primary network path 104 to router 123. Router 123 receives the data packets on interface S2.

Upon receipt, router 123 removes label L5 and adds respective labels L2 and LI to data packet 160 and data packet 170. For example, router 123 switches the label in received data packet 151. Router 123 then forwards data packet 160 over communication link 106 to router 122 and data packet 170 over communication link 107 to router 121 for further forwarding of the multicast data traffic to respective destinations. Based on this topology, a single root router 124 can multicast data traffic to multiple destinations in or associated with network 100.

According to one embodiment herein, router 124 in label-switching network 100 can anticipate occurrence of network failures that would prevent multicasting of respective data traffic. To support uninterrupted communications, router 124 sets up (e.g., configures a forwarding table to include) one or more backup paths on which to forward multicast data traffic in the event of a failure. For example, router 124 can anticipate a possible link failure 130 on primary network path 104. Accordingly, in this example, router 124 sets up backup path 105-1 on which to forward multicast data traffic in the event of link failure 130.

If link failure 130 occurs as shown in FIG. 1, router 124 forwards multicast data traffic as data packet 150 (instead of data packet 151) on backup path 105-1 to router 123 (e.g., a next hop downstream router) instead of transmitting data packet 151 over primary network path 104 to router 123. As will be discussed in FIG. 2, if router 123 (e.g., the next hop downstream router as opposed to primary network path 104) happens to fail, the router 124 can circumvent sending the multicast data traffic to router 123 and instead send the multicast data traffic or through on respective backup paths to a set of routers (e.g., next next hop downstream routers or router 122 and router 121 network this example) that router 123 normally would forward the multicast data traffic received from router 124 in the absence of the network failure.

Referring again to FIG. 1 and the present example, as discussed above, if a communication link failure 130 occurs on primary network path 104 (e.g., communication link as opposed to node) normally used to forward the multicast data traffic to the next hop downstream router, then router 124 forwards the multicast data traffic on the backup path 105-1 to the next hop downstream router (e.g., router 123).

In one embodiment, when transmitting the multicast data traffic on such a backup path 105-1, the router 124 appends an extra label (e.g., label LT1) to the data packet 150. Data packet 150 thus includes an extra label compared to data packet 151 normally sent to router 123 in the absence of network failure 130. In this example, router 124 includes label LT1 in data packet 150 for purposes of forwarding multicast data traffic on the backup path 105-1 to router 123. Thus, embodiments herein support initiating label-stacking techniques to forward the multicast data traffic over one or more backup paths. That is, data packet 150 includes a stack of labels L5 and LT1 that are used for routing purposes.

In addition to techniques as discussed above, note that configuring the router 124 or network 100 to include one or more backup path 105 with respect to a primary network path 104 can include utilizing a respective backup path, which is used to route unicast data traffic, on which to forward the multicast data traffic in response to detecting network failure 130.

As discussed above, the extra label (e.g., LT1) in data packet 150 facilitates routing of the multicast data traffic on the backup path 105-1. For example, in one embodiment, backup path 105-1 is a pre-configured tunnel for carrying data packets in the event of a network failure. Such a tunnel can be configured to support unicast and multicast communications or just multicast communications. In the latter case, the router 124 would include a smaller set of forwarding information to manage.

Router 124 includes forwarding information to forward the multicast data traffic on primary network path 104 when there is no network failure and forward the multicast data traffic on backup path 105-1 in the event of a respective network failure. Note that depending on the embodiment, backup path 105-1 can be a single communication link without any respective routers or include multiple communication links and multiple routers through which to forward the multicast data traffic to router 123 in the event of network failure 130.

According to further embodiments herein, the pre-configured backup path 105-1 (e.g., tunnel) can support an operation of stripping off the extra label LT1 from data packet 150 (and other respective data packets in a corresponding data stream) prior to reaching router 123 (e.g., the next hop downstream router) so that router 123 receives the same data packet formatting that would have been otherwise received on the primary network path 104 from router 124 if the network failure 130 did not occur. However, note in this example that during normal operations in the absence of network failure 130, router 123 receives data packets associated with the multicast data traffic from router 124 on interface S2. During a respective network failure 130, router 123 receives multicast data traffic from router 124 on interface Si of router 123.

Since the multicast data traffic (e.g., data packet 150 and the like) can be received on an interface (e.g., Si) associated with the backup path 105-2 in lieu of the primary network path 104 in which respective data packets would be received on interface S2, RPF (Reverse Path Forwarding) checking can be disabled at router 123 according to one embodiment herein. In this embodiment, instead of implementing conventional RPF checking on the data packets received at router 123, the router 123 uses label checking techniques to verify the received data packets.

For example, the router 123 receiving the multicast data traffic on the backup path 105-1 checks the corresponding label L5 in data packet 150 and the like to identify whether such data should be received at router 123 and forwarded on through network 100. In this example, router 123 checks whether the label in data packet 150 corresponds to a respective label normally received by the router 123 to further route corresponding data payloads through router 123 to yet other downstream routers. Accordingly, the router 123 implementing the label-checking techniques and receiving the multicast data traffic (and proper label) from either the primary network path 104 or backup path 105-1 need only receive the data packet (150 or 151), verify that received data packets include appropriate labels of traffic normally routed through router 123 and change the respective label on incoming data packets for purposes of forwarding the multicast data traffic to yet other downstream routers toward the appropriate destinations. Thus, in the present example, the router 123 can receive either data packet 150 or data packet 151 (depending on whether a respective network failure 130 occurs) and forward the received multicast data traffic in such data packets to respective router 122 and router 121 via use of switching label L2 and L1 as shown.

FIG. 2 is a diagram of network 100 in which data communication devices such as so-called routers support point-to-multipoint communications according to an embodiment herein. Note that embodiments herein also anticipate failures with respect to so-called next hop downstream routers. For example, router 124 can identify router 123 as a next hop router that could possibly fail during multicasting of respective data traffic.

In this example, router 124 pre-configures network 100 (e.g., its forwarding information) to include backup paths 105-2 and backup path 105-3 on which to forward multicast data traffic in the event of a network failure such as node failure 131. Note that the present example includes two next next hop downstream routers with respect to router 124 for illustrative purposes. However, techniques herein can be extended to any number of next next hop downstream routers and respective backup paths.

More specifically, based on learning that downstream router 123 could potentially fail, router 124 learns of a successive set of one or more nodes (e.g., next next hop downstream routers) to which router 123 normally forwards the multicast data traffic in the absence of node failure 131. In this example, router 124 learns that router 122 and router 121 are both next next hop downstream routers with respect to router 124 because router 123 normally forwards multicast data traffic on respective communication link 106 and communication link 107 to router 122 and router 121 in the absence of a node failure 131. As discussed above, router 123 is an example of a next hop downstream router with respect to router 124.

In addition to learning the next next hop downstream routers with respect to 124, router 124 also learns of the switching labels that the next hop downstream router (e.g., router 123) normally would use to forward traffic to respective next next hop downstream routers (e.g., router 122 and router 121). In this example, router 124 knows that router 123 normally forwards multicast data traffic to router 122 via use of label L2 and that router 123 normally forwards multicast data to router 121 via use of label L1.

Based on knowing the next next hop downstream routers, router 124 pre-configures a respective forwarding table to include backup path 105-2 (e.g., a tunnel) and backup path 105-3 (e.g., a tunnel) in order to circumvent transmission of the multicast data traffic through a failing node in network 100. Thus, in the event that a network failure (e.g., a link failure or node failure), router 124 can append the appropriate label (e.g., label L2 and L1) to the data packets carrying the multicast data traffic when using the backup paths 105-1 and 105-2 to forward the multicast data traffic. Thus, a receiving node such as router 122 can receive the data packet 152, which includes the label L2 that router 122 would normally receive in data packets from router 123. Also, a receiving node such as router 121 can receive the data packet 153, which includes the label L1 that router 121 would normally receive in data packets received from router 123.

As previously discussed, in the absence of node failure 131, router 124 would normally send the multicast data traffic with appended label L5 to router 123. Router 123 would in turn forward the multicast data traffic (e.g., as data packets 160 and 170) to respective routers 122 and 121 via use of labels L2 and L1.

Similar to the backup path techniques as discussed above, during a node failure 131 in the present example, the router 124 can append one or more additional labels to data packets carrying the multicast data traffic for purposes of forwarding the multicast data traffic over respective one or more backup path 105-2 and/or backup path 105-3. For example, in the event of node failure 131, router 124 appends label LT2 to data packet 152 (e.g., via label-stacking techniques) for purposes of forwarding the data packet 152 along backup path 105-2. Additionally, router 124 appends label LT3 to data packet 153 for purposes of forwarding the data packet 153 along backup path 105-3. Note again that backup paths 105-2 and 105-3 each can include one or more routers and/or communication links on which to forward the data packets.

A respective backup path 105 (e.g., tunnel), which is used to circumvent a failing next hop downstream router (e.g., router 123 in this example), can strip the respective extra label (e.g., label LT2 or LT3 as the case may be) off the data packets 152 and 153 prior to final forwarding to respective next next hop downstream routers (i.e., router 122 and router 121) so that the next next hop downstream routers receive the same data packet formatted multicast data traffic that they would have otherwise received from router 123 in the absence of node failure 131. Accordingly, the respective routers 122 and 121 receive the same formatted data packet from the router 124 that they would have received if it were instead sent through router 123 in the normal mode. However, in the case of node failure 131, the respective routers 122 and 121 receive the data packet on a different interface than they would normally receive data packets 160 and 170. In a similar way as discussed above, routers 122 and 121 can disable conventional RPF checking and instead rely on label-checking techniques to verify appropriate receipt of data.

In one embodiment, use of the label-checking techniques speeds up forwarding of the multicast data traffic through network 100 because the receiving node need only verify that the data packet includes a respective label that would normally be received at the node and switch the label of the data packet for yet further forwarding of the multicast data traffic through network 100.

Note that a decision to forward multicast data traffic in network 100 can vary depending on the particular embodiment. For example, in one embodiment, router 124 can establish the backup paths 105 (e.g., backup path 105-1, backup path 105-2, backup path 105-3) as discussed above in FIGS. 1 and 2. However, the router 124 can selectively forward the multicast data traffic on one of the first backup path 105-1 or set of second backup paths 105-2 and 105-3 depending on whether the router 123 is an edge router (e.g., a provide edge router) in the network 100. If router 123 is not an edge router (e.g., the router 123 is a core router in a respective service provider network), then router 124 may choose to forward the multicast data traffic on the set of backup paths 105-2 and 105-3 regardless of the type of network failure that occurs.

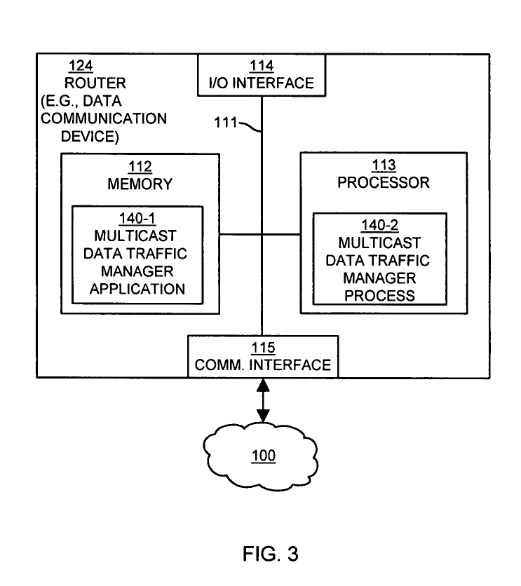

FIG. 3 is a block diagram illustrating an example architecture of a router 124 or, more generally, a data communication device such as a router, hub, switch, etc. in label-switching network 100 of FIG. 1 for executing a multicast data traffic manager application 140-1 according to embodiments herein. According to one embodiment as discussed above, multicast data traffic manager application 140-1 enables uninterrupted transmission of multicast data traffic in the event of a network failure as discussed above via use of backup paths 105.

Router 124 (i.e., data communication device) may be a computerized device such as a personal computer, workstation, portable computing device, console, network terminal, processing device, router, server, etc. As shown, router 124 of the present example includes an interconnect 111 that couples a memory system 112, a processor 113, I/O interface 114, and a communications interface 115. 1/0 interface 114 potentially provides connectivity to optional peripheral devices such as a keyboard, mouse, display screens, etc. Communications interface 115 enables router 124 to receive and forward respective multicast data traffic as well as other types of traffic (e.g., unicast data traffic) over label-switching network 100 to other data communication devices (e.g., other routers).

As shown, memory system 112 is encoded with a multicast data traffic manager application 140-1 supporting enhanced multicast data traffic techniques as discussed above and as further discussed below. Multicast data traffic manager application 140-1 may be embodied as software code such as data and/or logic instructions (e.g., code stored in the memory or on another computer readable medium such as a disk) that supports processing fulnctionality according to different embodiments described herein. During operation, processor 113 accesses memory system 112 via the interconnect 111 in order to launch, run, execute, interpret or otherwise perform the logic instructions of the multicast data traffic manager application 140-1. Execution of the multicast data traffic manager application 140-1 produces processing functionality in multicast data traffic manager process 140-2. In other words, the multicast data traffic manager process 140-2 represents one or more portions of the multicast data traffic manager application 140-1 (or the entire application) performing within or upon the processor 113 in the router 124. It should be noted that, in addition to the multicast data traffic manager process 140-2, embodiments herein include the multicast data traffic manager application 140-1 itself (i.e., the un-executed or non-performing logic instructions and/or data). The multicast data traffic manager application 140-1 may be stored on a computer readable medium such as a floppy disk, hard disk or in an optical medium. The multicast data traffic manager application 140-1 may also be stored in a memory type system such as in firmware, read only memory (ROM), or, as in this example, as executable code within the memory system 112 (e.g., within Random Access Memory or RAM). In addition to these embodiments, it should also be noted that other embodiments herein include the execution of multicast data traffic manager application 140-1 in processor 113 as the multicast data traffic manager process 140-2. Thus, those skilled in the art will understand that the router 124 (e.g., a data communication device or computer system) can include other processes and/or software and hardware components, such as an operating system that controls allocation and use of hardware resources.

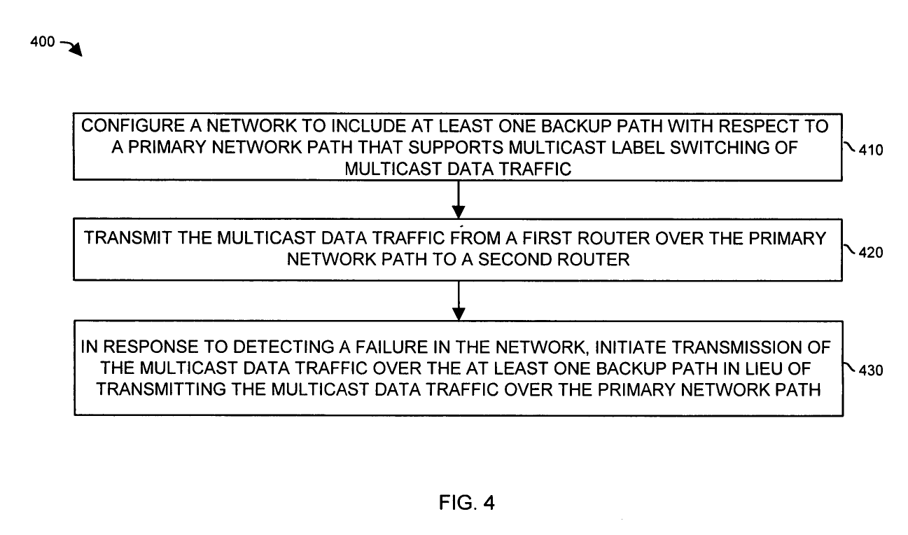

Functionality supported by router 124 and, more particularly, multicast data traffic manager 140 will now be discussed via flowcharts in FIG. 4-7. For purposes of this discussion, router 124 such as a core router in a respective service provider network generally performs the multicast data traffic manager application 140 to carry out steps in the flowcharts. This functionality can be extended to the other entities in network 100 as opposed to operating in any single device.

Note that there will be some overlap with respect to concepts and techniques discussed above for FIGS. 1 through 3. Also, note that the steps in the below flowcharts need not always be executed in the order shown.

FIG. 4 is a flowchart 400 illustrating a technique of enhancing a label-switching network to set up backup paths 105 on which to forward multicast data traffic according to an embodiment herein. As discussed, one purpose of setting up backup paths 105 is to provide uninterrupted multicast communications in network 100 in the event of a link or node failure.

In step 410, router 124 configures network 100 to include at least one backup path 105 with respect to a primary network path 104 that supports multicast label switching and forwarding of multicast data traffic.

In step 420, router 124 transmits the multicast data traffic in respective data packets over the primary network path 104 to router 123.

In step 430, in response to detecting a failure in the network 100, router 124 initiates transmission of the multicast data traffic in respective data packets over the one or more backup paths 105 in lieu of transmitting the multicast data traffic over the primary network path 104.

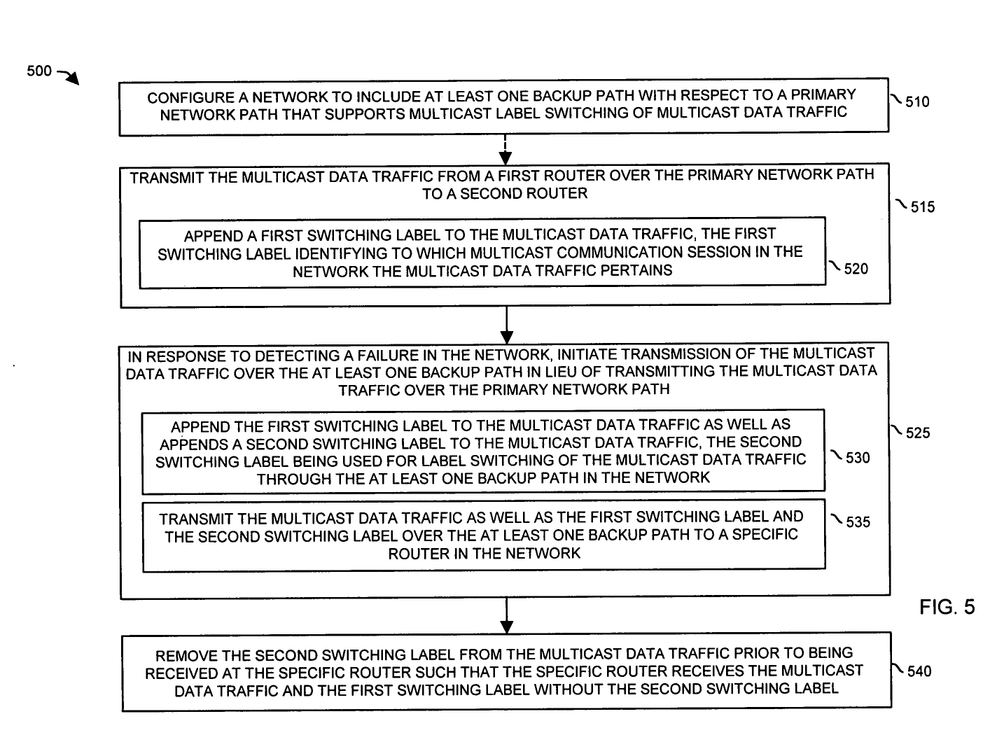

FIG. 5 is a flowchart 500 illustrating more specific techniques for utilizing respective backup paths to enhance multicast communications according to an embodiment herein.

In step 510, router 124 configures network 100 to include at least one backup path with respect to a primary network path 104 that supports multicast label switching of multicast data traffic.

In step 515, router 124 transmits the multicast data traffic as respective data packets over the primary network path 104 to router 123.

In sub-step 520 of step 515, router 124 appends a first switching label (e.g., L5) to the multicast data traffic. The first switching label L5 identifies to which multicast label-switching communication session in the network 100 the multicast data traffic pertains.

In step 525, in response to detecting a failure in network 100, router 124 initiates transmission of the multicast data traffic over the at least one backup path 105 in lieu of transmitting the multicast data traffic over the primary network path 104.

In sub-step 530 of step 525, router 124 appends the first switching label L5 to the multicast data traffic as well as appends a second switching label LT1 to the multicast data traffic. The second switching label LT1 is used for label switching of the multicast data traffic through the backup path 105-1 in the network 100.

In sub-step 535 of step 525, router 124 transmits the multicast data traffic as well as the first switching label L5 and the second switching label LT1 over the at least one backup path 105-1 to router 123 in the network 100.

In step 540, backup path 105-1 (e.g., a tunnel) removes the second switching label LT1 from the multicast data traffic prior to receipt of the multicast data traffic at router 123 such that router 123 receives the multicast data traffic and the first switching label L5 without the second switching label LT1 (e.g., a tunnel label). Accordingly, router 123 need not be aware or concerned that a respective link failure occurred in the primary network path 104.

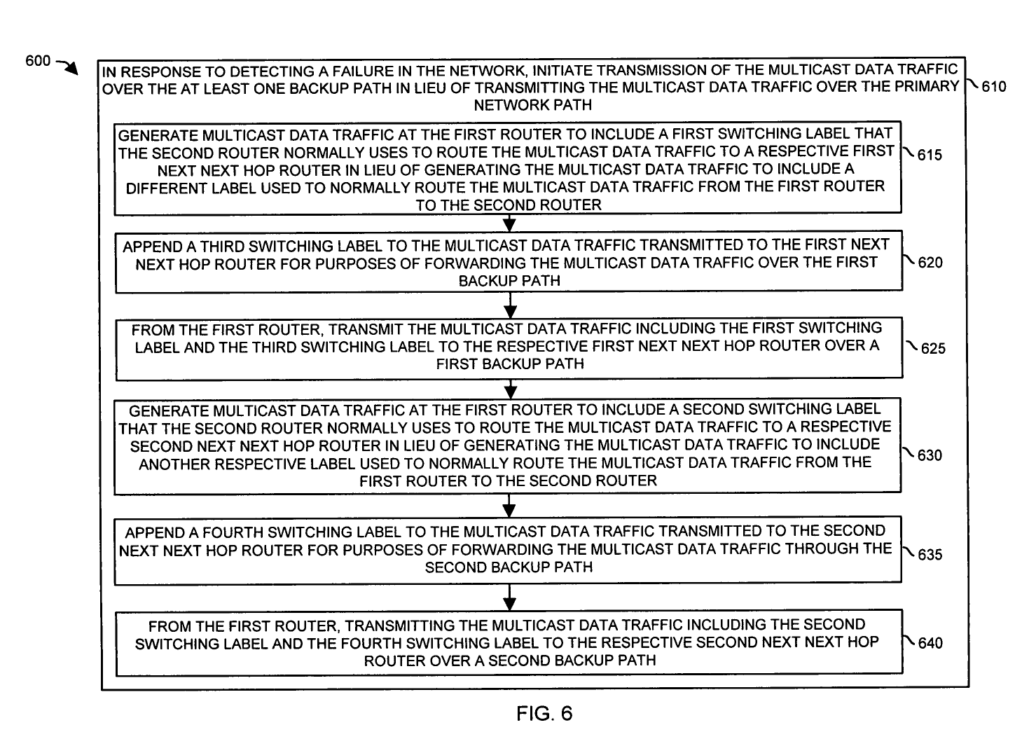

FIG. 6 is a flowchart 600 illustrating more specific techniques for supporting multicast communications in a label-switching network in the event of a node failure according to an embodiment herein.

In step 610, in response to detecting a node failure in the network, the router 124 initiates transmission of the multicast data traffic over the backup path 105-2 and backup path 105-3 in lieu of transmitting the multicast data traffic over the primary network path 104. This involves execution of the following sub-steps 615-640 as described below.

In sub-step 615 associated with step 610, the router 124 generates multicast data traffic to include a first switching label (e.g., L2) that the second router 123 normally uses to route the multicast data traffic to a respective first next next hop router (e.g., router 122) in lieu of generating the multicast data traffic to include a different label (e.g., L5) used to normally (when there is no network failure condition at router 123) route the multicast data traffic from the router 124 to router 123.

In sub-step 620 associated with step 610, the router 124 appends a third switching label (e.g., LT2 such as tunnel label 2) to the multicast data traffic transmitted to the first next next hop router (e.g., router 122) for purposes of forwarding the multicast data traffic over backup path 105-2.

In sub-step 625 associated with step 610, the router 124 transmits the multicast data traffic including the first switching label (e.g., L2) and the third switching label (e.g., LT2) to the respective first next next hop router (i.e., router 122) over backup path 105-2.

In sub-step 630 associated with step 610, the router 124 generates multicast data traffic to include a second switching label (e.g., L1) that the router 123 normally uses (when there is no network failure condition at router 123) to route the multicast data traffic to a respective second next next hop router (e.g., router 121) in lieu of generating the multicast data traffic to include a label (e.g., L5) normally used to route the multicast data traffic from router 124 to the router 123.

In sub-step 635 associated with step 610, the router 124 appends a fourth switching label (e.g., LT3 such as tunnel label 3) to the multicast data traffic transmitted to the second next next hop router (e.g., router 121) for purposes of forwarding the multicast data traffic through the backup path 105-3 to the router 121.

In sub-step 640 associated with step 610, the router 124 transmits the multicast data traffic including the second switching label (e.g., L1) and the fourth switching label (e.g., LT3) to the respective second next next hop router (e.g., router 121) over the backup path 105-3.

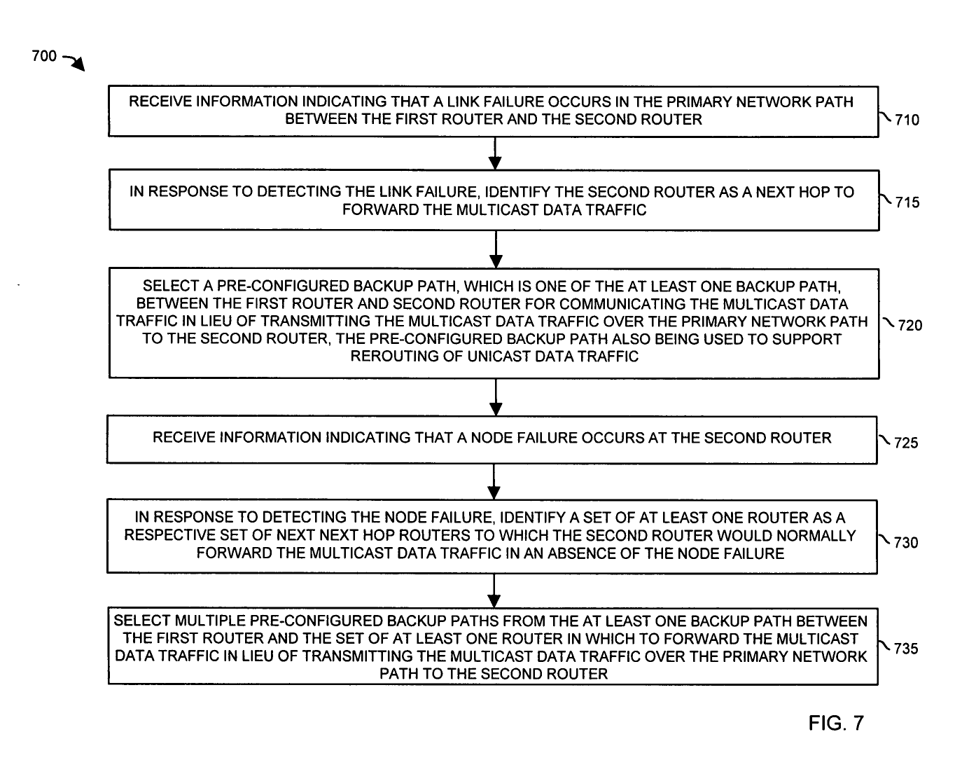

FIG. 7 is a flowchart 700 illustrating more specific techniques for supporting multicast communications in a label-switching network in the event of a node failure according to an embodiment herein.

Steps 710, 715 and 720 of flowchart 700 illustrate a procedure to support continued multicast communications in the event of detecting a link failure 130 on primary network path 104.

In step 710, router 124 receives information indicating that a link failure 130 occurs in the primary network path 104 between the router 124 and the router 123.

In step 715, router 124 identifies router 123 as a next hop router to forward the multicast data traffic in response to detecting the link failure 130.

In step 720, router 124 selects pre-configured backup path 105-1, which is one of the potentially multiple backup path 105, between the router 124 and router 123 for communicating the multicast data traffic in lieu of transmitting the multicast data traffic over the primary network path 104 to the router 123. In one embodiment, the pre-configured backup path 105-1 is also used to support rerouting of unicast data traffic.

Steps 725, 730, and 735 of flowchart 700 illustrate a procedure to support continued multicast communications in the event of detecting a node failure at router 123.

In step 725, router 124 receives information indicating that a node failure 131 occurs at router 123.

In step 730, in response to detecting the node failure at router 123, router 124 identifies a set of one or more routers (e.g., router 122 and router 121) as a respective set of next next hop routers to which the router 123 would normally forward the multicast data traffic in an absence of the node failure.

In step 735, router 124 selects multiple pre-configured backup paths 105-2 and 105-3 between the router 124 and each router in the set of one or more next next hop downstream routers in which to forward the multicast data traffic in lieu of transmitting the multicast data traffic over the primary network path 104 to the router 123.

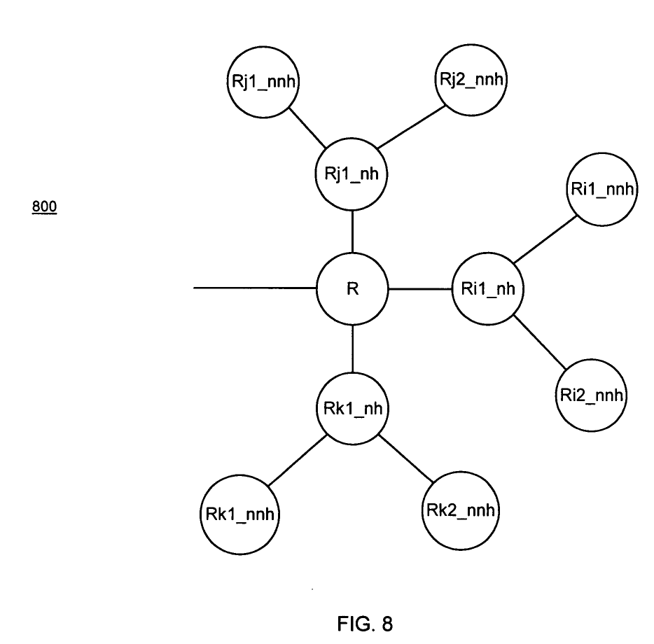

FIGS. 8-12 include further details associated with techniques herein. In general, section I below describes how to use path vectors distributed by LDP to determine constrained based backup path tunnels for multicast FRR. The procedure in section II describes how the NNHOP (Next Next Hop) nodes can be discovered and how the NNHOP multicast labels can be distributed. The procedure in section III describes how the multicast traffic can be accepted from an alternate interface.

Note that according to one embodiment herein, only the unicast Path Vector is distributed and used in this multicast FRR procedure. The multicast Path Vector need not be used for scalability reasons.
I) A method of building multicast backup path tunnels using unicast LDP

LDP includes a loop detection mechanism designed to prevent creation of LSPs that loop. Use of this mechanism is optional. When two LDP speakers establish an LDP session, they negotiate whether to use loop detection. When loop detection is enabled, LDP label mapping and label request messages carry path vectors and hop counts. A path vector is an ordered list of the LSRs through which signaling for the LSP being established has traversed. The hop count is the number of hops from the sending router to the destination or egress router.

If an LSR receives a label mapping message with a path vector that includes itself, the LSR knows that the LSP path has loops. More details on the LDP loop mechanism can be found in RFC 3036 (Request For Comment 3036). This document describes the use of path vectors for the purpose of determining loop free backup paths that are different from the paths determined by routing. The method requires the use of LDP downstream unsolicited label distribution, it assumes liberal label retention and ordered control modes.
1. Point to Multipoint Backup Paths:

FIG. 8 is a diagram of a label-switching network 800 illustrating a group of one or more router devices supporting forwarding techniques according to an embodiment herein. Unlike unicast, multicast has a higher number of route next-hops and next-next-hops in a respective downstream path to a destination. Therefore, according to embodiments herein, multicast requires more NHOP and NNHOP tunnels to protect the multicast tree traffic.

For example, zs shown in label-switching network 800, if R has multicast tree has branches R_branch={Ri_nh, Rj_nh, Rk_nh} with leafs R_leaf={Ri1_nnh, Ri2_nnh, Rj1_nnh, Rj2_nnh, Rk1_nnh, Rk2_nnh}. Where Rx_nh is the router R's next-hop and Rxx__nnh is the router R's next next-hop.

R has the following next-hops={Ri_nh, Rj_nh, Rk_nh}.

R has the following next-next-hops={Ri1_nnh, Ri2_nnh, Rj1_nnh, Rj2_nnh, Rk1_nnh, Rk2_nnh}.

For link protection R needs to establish NHOP tunnels from R to each of its next-hop {Ri_nh, Rj_nh, Rk_nh}. R to Ri_nh NHOP tunnel must avoid the link (R-Ri_nh, R to Rj_nh NHOP tunnel must avoid the link (R-Rj_nh) and R to Rk_nh NHOP tunnel must avoid the link (R-Rk_nh). In the point to multipoint link protection, if there are P links on a tree, then one creates P NHOP tunnels.

For node protection purposes, router device R establishes NNHOP tunnels from R to each of its next-next-hop {Ri1_nnh, Ri2_nnh, Rj1_nnh, Rj2_nnh, Rk1_nnh, Rk2_nnh}. R to Ri1_nnh NNHOP tunnel must avoid the node Ri_nh; R to Ri2_nnh NNHOP tunnel must avoid the node Ri_nh; R to Rj1_nnh NNHOP tunnel must avoid the node Rj_nh; R to Rj2_nnh NNHOP tunnel must avoid the node Rj_nh; R to Rk1_nnh NNHHOP tunnel must avoid the node Rk_nh; and R to Rk2_nnh NNHOP tunnel must avoid the node Rk_nh. As illustrated, for the point to multipoint node protection, if you have M next-next-hop neighbors in the tree, then you need M NNHOP tunnels.
2. Selecting NHOP and NNHOP Backup Paths:

When the Path Vector is enabled along with the label distribution, the associated path is known for a received label. A router can receive different path from each of its neighbors. One of such paths can used as a backup path.
i) NHOP LDP Backup Path

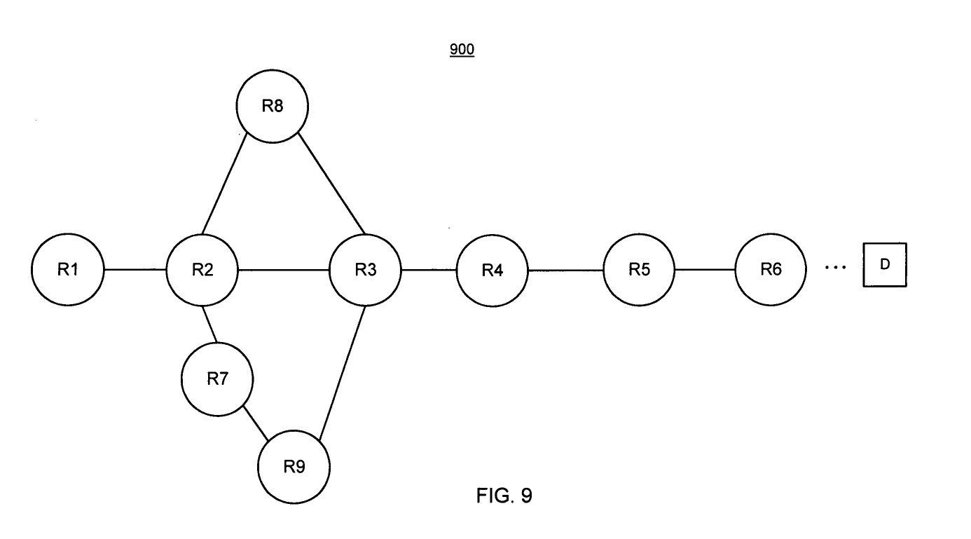

FIG. 9 is a diagram of a label-switching network 900 illustrating forwarding techniques according to an embodiment herein. Assume that R2's next hop for downstream destination D is R3. In one embodiment, the goal is to determine a path for destination D at R2 which protects against the failure of the R2-R3 link. The path would be a NHOP backup path and its constraints are:

C1. Avoid R2-R3 Link

C2. Select Shortest Path (Where the Metric is Hop Count)

To calculate the NHOP backup path, consider the path vectors (e.g., paths) at R2 for D:

P1. R6, R5, R4, R3, R2, length 4

P2. R6, R5, R4, R3, R8, R2, length 5

P3. R6, R5, R4, R3, R9, R7, R2, length 6

Path vectors P2 and P3 both satisfy constraint C1 by avoiding the R2-R3 link, and path P2 satisfies constraint C2 because it is the shorter. Therefore, path vector P2 contains the NHOP backup path. If P2 and P3 had been of equal length, either one or both could have been selected as a backup path. In principle, additional constraints for which LDP has sufficient information to enforce could be added to the path selection constraint set.

The first 3 elements of the path vectors above are irrelevant to the path selection since the desired NHOP path originates at R2 and terminates at R3. The path selection computation could have been performed on the following truncated path vectors. However, it would yield the same result:

P1′. R3, R2, length 1

P2′. R3, R8, R2, length 2

P3′. R3, R9, R7, R2, length 3
(ii) NNHOP LDP Backup Path

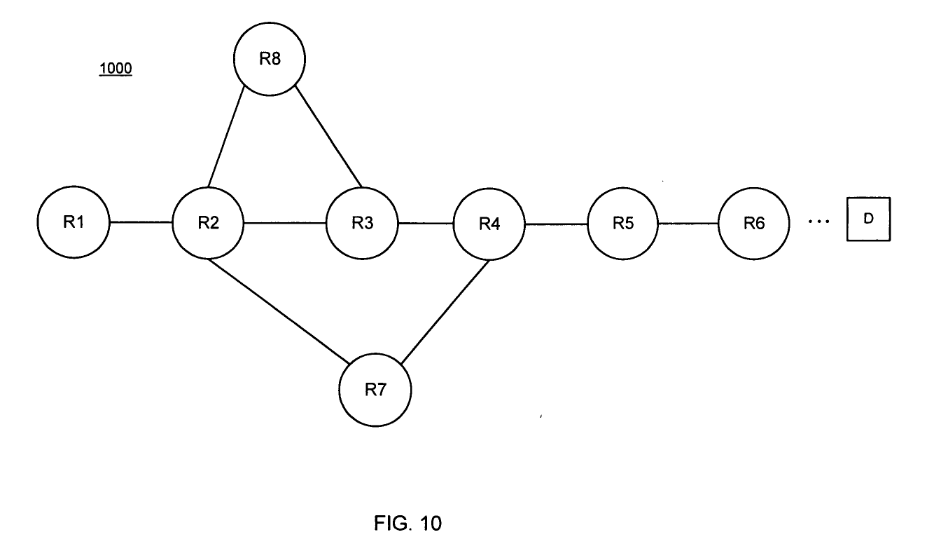

FIG. 10 is a diagram of a label-switching network 1000 illustrating forwarding techniques according to an embodiment herein.

Assume that we wish to determine a path for destination D at R2 which protects against the failure of the LSR R3. This would be a NNHOP backup path and the constraints are:

C1. Avoid Node R3

C2. Select Shortest Path

To calculate the NNHOP backup path consider the path vectors at R2 for D, the respective lengths are as follows:

P1. R6, R5, R4, R3, R2, length 4

P2. R6, R5, R4, R3, R8, R2, length 5

P3. R6, R5, R4, R7, R2, length 4

Here only path P3 satisfies constraint C1 and, since P3 is the only path, it is the shortest path as well.
3. Building U-turn Based NHOP and NNHOP Backup Tunnels

Some router nodes may not have a local backup link. In this case, one solution is to take a reverse path or traveling backup to the upstream nodes to go to a node which has the path to NHOP or NNHOP. According to embodiments herein, this requires the special label allocation and distribution mechanism described in U.S. Patent application Ser. No. 11/203,801 (Attorney docket number CIS05-31), the entire teachings of which are incorporated herein by reference. To achieve the U-turn, this patent application indicates that a selected alternate or backup can be distributed to its routed next-hop. In this case, the selected backup path can be a NHOP or NNHOP or both NHOP and NNHOP. Even if one distributes any of these backup paths, one may not be able to create get the U-turn based NHOP or NNHOP.

When distributing either NHOP or NNHOP backup path to the next-hop router this does not necessarily provide a useful U-turn path for the downstream nodes. For example, if a router distributes the NNHOP backup path to its route next-hop, it can provide only NHOP backup path with one hop U-turn path only for the next-hop downstream node. If the router distributes the NHOP backup path to its route next-hop, it can provide neither NHOP path nor NNHOP U-turn path for its downstream node.

Even though there is only need for NHOP or NNHOP backup paths, there may be a need to distribute the backup path from any node to all the destinations to its route next-hop. This backup path must be a “backup path which merges near a destination,” which is used in the unicast FRR backup paths. This allows any node to use NHOP and NNHOP backup path tunnels with any number of hops U-turn. This technique can provide better protection coverage and eliminate the need for introducing additional links to achieve protection coverage.

The following paragraphs provide details on label and path vector advertisements for any number of hop reverse path based U-turns for the NHOP and NNHOP tunnels.

A. Local Label Assignment. LDP assigns two local labels (Lr, La) for a prefix. The intent is to use Lr for the normally routed LSP and La for the alternate path LSP.

B. Label Advertisement. LDP advertises one of unicast<Lr, PVr> or <La, PVa> to each of its peers where PVr is a routed Path Vector and PVa is a “backup Path Vector merging closer to destination”.

It advertises label<Lr, PVr> to every peer that is not a routing next hop for the prefix and label <La, PVa>to every peer that is a routing next hop.
4. Backup Path Loop Detection:

Normally there are two types of backup path loops:

(a) Loop created with a single backup path

(b) Loop created with a multiple backup path
For loop (a), the backup path can be a looping backup path. This can be detected via the procedure defined in the RFC3036.
For loop (b), a loop can also be created with multiple paths as follows:

(i) Loop between primary and backup paths

(ii)Loop between 2 or more backup paths

The loop between the primary and backup path cannot exist in this case because, the backup paths are always made to the downstream NHOP or NHHOP nodes. In the steady state, the packets generally will not travel upstream. Therefore, there are no steady state loops.

A loop between 2 or more backup paths can happen as in the case of unicast for the same reasons. The same loop detection procedure can be used to detect these loops.
5. Unicast Backup Path and Multicast Backup Co-existence

Even though the unicast and multicast uses two different types of backup paths, there is no conflict between these backup paths. According to one embodiment herein, the key is distribution of “backup path merging closer to destination” to route next-hop for both unicast and multicast Path Vector distribution. Therefore, a customer such as the owner of a service provider network can use both unicast backup and multicast backup at the same time.
6. Multicast Link Protection

For link protection, the multicast local label form NHOP node is distributed to the PLR in the normal LDP message. This is a remote label from NHOP. When PLR detects the link failure, it pushes the NHOP node's multicast tree local label and the unicast backup label for the destination “NHOP”, in the packet and forwards the packet with the following two labels:
(data+NHOP's multicast local label+unicast Backup label for the destination “NHOP”)

Backup path starts at PLR and end at a NHOP. When packet reaches the penultimate hop of NHOP, the top label is popped and the packet reaches the NHOP with a correct multicast tree label. The platform level labels and the RPF procedure (III) are used for multicast trees, forwarding involves just forwards the packets as if it was received from the previous hop.

For link protection, as it stated earlier, the NHOP node is identified very easily from the LDP router ID. Similarly NHOP multicast local is nothing but the remote multicast label from the NHOP in the current LDP label distribution mechanism. In one embodiment, it is possible to implement both NHOP node and its multicast local label for link protection purposes.
(II) A method of discovering NNHOPs and distributing NNHOP multicast Labels
1. Multicast Node Protection Issues

For node protection, the multicast local label from NNHOP node needs to be distributed to PLR. When the PLR detects the failure, it pushes the NNHOP node's multicast tree local label and the unicast backup label for the destination “NNHOP”, in the packet and forwards the packet with the following two labels:
(data+NNHOP's multicast local label+unicast Backup label for the destination “NNHOP”)

The backup path starts at PLR and ends at “NNHOP”. When the packet reaches the penultimate hop of “NNHOP”, the top label is popped and the packet reaches the NNHOP with a correct multicast label. The platform level labels and the RPF procedure (III) are used for multicast trees, forwarding just forwards the packets as if it was received from the previous hop.
2. NNHOP Node Discovery and Label Distribution Mechanism

Conventional LDP multicast label distribution procedures do not have the capability to discover NNHOP. The NNHOP node discovery mechanism may be used in several applications such as unicast IP FRR, unicast LDP FRR, and multicast IP FRR and multicast LDP FRR. Therefore, embodiments herein include a new general NNHOP discovery mechanism. This can be introduced in the current LDP label distribution procedure in the following ways:

(i) Use of downstream unsolicited mode as described in Appendix A for NNHOP and its label distribution.

(ii) Use of U-bit and F-bit procedure in the RFC3036 can be used to distribute the NNHOP and its label distribution.

(i) Use of downstream unsolicited mode with as described in Appendix A for NNHOP and its label distribution.

According to one embodiment, a router requests the NNHOP label and, in response, the NNHOP label is received. In this case, the label requesting router must know its NNHOP. However, in some procedures, the routers may not know the NNHOPs. In such a case, the downstream on demand based label distribution procedure cannot be used.

Therefore, according to one embodiment herein, a downstream unsolicited NNHOP procedure is used to introduces NNHOP label distribution. In the downstream unsolicited NNHOP procedure, the route distributes the NNHOP Label Mapping message without the NNHOP Label Request message.

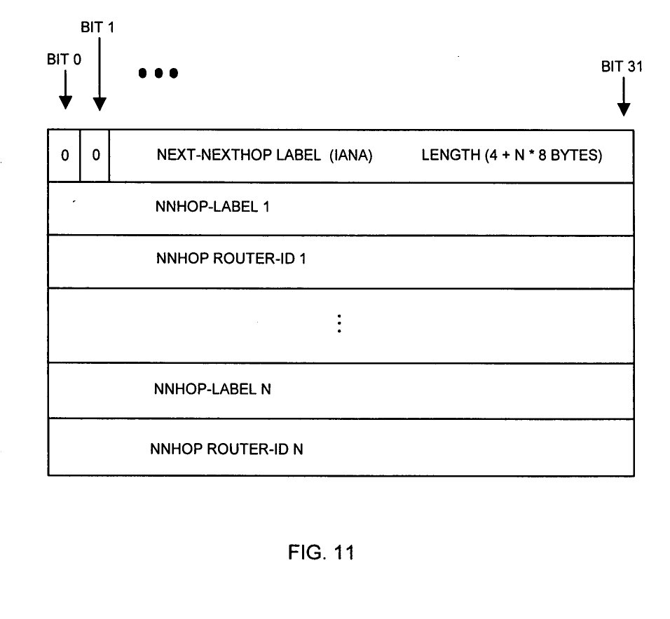

The Next-Nexthop Label TLV can be optionally carried in the Optional Parameters field of a Label Mapping Message. The TLV consists a list of (label, router-id) pairs with the format as shown in FIG. 11.
NNhop-Label
   Next-Nexthop Label. This is a 20-bit label value as specified in [4] represented as a 20-bit number in a 4 octet field.
NNhop Router-ID
   Next-Nexthop router-ID which advertised that next-nexthop label.
   This is a 4 octet number.

In the LDP unicast case, when the Label Mapping message is distributed, the optional “Next-Nexthop Label TLV” is also carried along without the explicit Label Request. When an upstream node receives this message, it knows about all its NNHOP router-ID and the associated NNHOP label for that FEC. With such information, the node can build the LDP backup path tunnels.

In the LDP multicast label distribution procedure, when the P2MP (i.e., point-to-multipoint) or MP2MP (i.e., multipoint-to-multipoint) label is distributed, the optional “Next-Nexthop Label TLV” must be carried multiple times in the same Label Mapping message. When an upstream node receives this message, it knows about all its NNHOP router-ID and the associated NNHOP label for that multicast FEC. Now, the upstream node can build the node protecting LDP backup path tunnels.

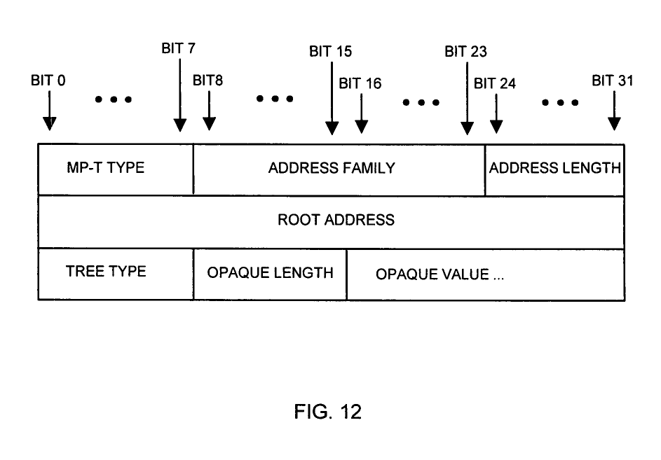

The MP-T FEC element identifes an MP-T by means of the tree's root address, the tree type and information that is opaque to core LSRs. MP-T type FEC Element encoding is shown in FIG. 12.:
MP-T Type
   This is the MP-T type FEC element, value to be assigned by IANA.
Address Family
   Two octet quantity containing a value from ADDRESS FAMILY NUMBERS in [RFC 1700] that encodes the address family for the Root address field.
Address Length
   Length of the Root address value in octets.
Root Address
   The root address of the MP-T. Used by receiving LSR to determine the next-hop toward the MP-T root.
Tree Type
   one octet that identifies the tree type
      P2MP LSP.
      MP2MP downstream LSP.
      MP2MP upstream LSP.
Opaque Len
   Length of the opaque value in octets.
Opaque Value
   Variable length opaque value that uniquely identifies the MP-T.
The triple<Root Address, Tree Type, Opaque Value>uniquely identifies the MP-T. LDP uses the Root Address to determine the upstream LSR toward the MP-T; the Tree Type determines the nature of LDP protocol interactions required to establish the MP-T LSP; and, the Opaque Value carries information that may be meaningful to edge LSRs.

When an upstream node receives this message with the optional “Next-Nexthop Label TLVS” along with the above multicast FEC, it knows about all its NNHOP router-ID and the associated NNHOP label for that multicast FEC. Now it can build the node protecting LDP backup path tunnels.
(III) A method of receiving multicast packet on an alternate interface 1. RPF check during multicast

RPF stands for Reverse Path Forwarding. It is an algorithm used for forwarding IP multicast packets. According to one embodiment herein, the current IP multicast RPF rules are:

(1) If a router receives a packet on an interface that it uses to send unicast packets to the source or root of the tree, the packet has arrived on the RPF interface.

(2) If the packet arrives on the RPF interface, a router forwards the packet out the interfaces that are present in the outgoing interface list of a multicast routing table entry.

(3) If the packet does not arrive on the RPF interface, the packet is silently discarded. This provides loop avoidance.

The conventional RPF check rules makes it impossible to do fast reroute for multicast. In the fast reroute, after a component (link or node) failure up until the convergence, the traffic is sent through a backup path which may bring the multicast traffic through an interface which is not used for sending unicast packets to the source or root of the tree. That is, a router receives on an interface other than the IP RFP interface. Therefore, as discussed above, embodiments herein includes use of a new “label based check.” This check is introduced through MPLS multicast.

2. Label-based Checking in Lieu of Conventional RPF Checking

In this procedure, a unique ingress or local label is allocated for each tree and only distributed to its tree upstream node toward the source or root of the tree. This label is only known to the RPF neighbor. Therefore, the router only forwards the traffic with that label on to the tree. This functions similar to conventional RPF checking to the extent that it verifies that received traffic is coming from its RPF neighbor. However, this technique relaxes the strict requirement of packet only arriving through an ingress interface. Label based checking allows the packets coming through any physical interface as long as the label is same. This makes it easier to do multicast fast reroute.

2.1 Implementing Label-based RPF Check

The label-based RPF check can be implemented in the following ways:

(i) Virtual Label interface—For MPLS to IP case.

(ii) Label cross-connect—For MPLS to MPLS case.

The “Label interface” implementation provides closer analogy of multicast RPF check. In the multicast, currently RPF is checking the ingress interface before forwarding traffic on to the tree to avoid loops. The same check will be now done on the label interface. This makes the MPLS data plane function similar to the IP case.

This “label interface” is a virtual interface in the MRIB. This MPLS virtual interface was by having a read IDB with a new IDBTYPE. This new IDBTYPE called a LSPVIF. The MRIB expects to have an RPF interface when doing a L3 lookup. The virtual interface (LSPVIF) is that RPF interface. In the MFI a label will set the context of the input interface in the packet to this LSPVIF so that the RPF check will be successful.

The label cross-connect model is already used various MPLS applications such as MPLS TE and cell-mode MPLS. In this case, the forwarding rewrite will strictly specify that the only traffic with a particular ingress label will be transported on the LSP tree. In this case, the forwarding only implements the existing label swapping operation.
3. Multicast FRR

During the multicast FRR, after a component (link or node) failure up until the convergence, the traffic is sent through a backup path, which is not used for sending unicast packets to the source or root of the tree. In this case, the packets are received on a non RFP interface during the reroute. When the packets received on a non RPF interface, the “label based RPF” check allows the packets to be received on any non RPF interface. Thus reduce the traffic loss during fast reroute.

Multicast Protection Coverage:

In the unicast LDP FRR, a Path Vector can provide full coverage for both link and node failures. Since the same unicast based Path Vector tunnel procedure is used for the multicast FRR, this Path Vector procedure can provide the same coverage multicast FRR also.

Note again that techniques herein are well suited for use in applications such as providing more robust point-to-multipoint communications in a respective label-switching network. For example, Unicast Path Vector base backup procedure makes it possible to do both LDP unicast and multicast fast reroute in both link state and non-link state routing protocol IGPs. Also, from a router R, unicast backup tunnels can aggregate all multicast trees traffic to its NHOP or NNHOP nodes. However, it should again be noted that configurations herein are not limited to use in such applications and thus configurations herein and deviations thereof are well suited for other applications as well.

While this invention has been particularly shown and described with references to preferred embodiments thereof, it will be understood by those skilled in the art that various changes in form and details may be made therein without departing from the spirit and scope of the invention as defined by the appended claims.

[image]

[image]

[image]

[image]

[image]

[image]

[image]

What is claimed is:

1. A method to support fast rerouting in a network, the method comprising:
configuring the network to include at least one backup path with respect to a primary network path that supports multi-protocol label switching of multicast data traffic;
transmitting the multicast data traffic from a first router over the primary network path to a second router; and
in response to detecting a failure in the network, initiating transmission of the multicast data traffic over the at least one backup path in lieu of transmitting the multicast data traffic over the primary network path.

2. A method as in claim 1, wherein transmitting the multicast data traffic over the primary network path includes appending a first switching label to the multicast data traffic, the first switching label identifying to which multicast communication session in the network the multicast data traffic pertains; and
wherein initiating transmission of the multicast data traffic over the at least one backup path includes appending the first switching label to the multicast data traffic as well as appending a second switching label to the multicast data traffic, the second switching label being used for label switching of the multicast data traffic through the at least one backup path in the network.

3. A method as in claim 1, wherein initiating transmission of the multicast data traffic over the at least one backup path includes transmitting the multicast data traffic as well as the first switching label and the second switching label over the at least one backup path to a specific router in the network, the method further comprising:
removing the second switching label from the multicast data traffic prior to being received at the specific router such that the specific router receives the multicast data traffic and the first switching label without the second switching label.

4. A method as in claim 3, wherein initiating transmission of the multicast data traffic over the at least one backup path includes transmitting the multicast data traffic as well as the first switching label and the second switching label over a respective tunnel to the specific router, the second switching label being used to route the multicast data traffic through the respective tunnel to the second router.

5. A method as in claim 1, wherein detecting the failure in the network includes:
receiving information indicating that a link failure occurs in the primary network path between the first router and the second router;
in response to detecting the link failure, identifying the second router as a next hop to forward the multicast data traffic.

6. A method as in claim 5, wherein initiating transmission of the multicast data traffic over the at least one backup path includes:
selecting a previously established backup path, which is one of the at least one backup path, between the first router and second router for communicating the multicast data traffic in lieu of transmitting the multicast data traffic over the primary network path to the second router, the previously established backup path also being used to support rerouting of unicast data traffic.

7. A method as in claim 1, wherein detecting the failure in the network includes:
receiving information indicating that a node failure occurs at the second router;
in response to detecting the node failure, identifying a set of at least one router as a respective set of next next hop routers to which the second router would normally forward the multicast data traffic in an absence of the node failure.

8. A method as in claim 7, wherein initiating transmission of the multicast data traffic over the at least one backup path includes:
selecting multiple previously established backup paths from the at least one backup path between the first router and the set of at least one router in which to forward the multicast data traffic in lieu of transmitting the multicast data traffic over the primary network path to the second router.

9. A method as in claim 1, wherein initiating transmission of the multicast data traffic over the at least one backup path includes:
generating multicast data traffic at the first router to include a first switching label that the second router normally uses to route the multicast data traffic to a respective first next next hop router in lieu of generating the multicast data traffic to include a different label used to normally route the multicast data traffic from the first router to the second router; and
from the first router, transmitting the multicast data traffic including the first switching label to the respective first next next hop router over a first backup path.

10. A method as in claim 9, wherein initiating transmission of the multicast data traffic over the at least one backup path includes:
generating multicast data traffic at the first router to include a second switching label that the second router normally uses to route the multicast data traffic to a respective second next next hop router in lieu of generating the multicast data traffic to include another respective label used to normally route the multicast data traffic from the first router to the second router; and
from the first router, transmitting the multicast data traffic including the second switching label to the respective second next next hop router over a second backup path.

11. A method as in claim 10, wherein initiating transmission of the multicast data traffic over the at least one backup path includes:
appending a third switching label to the multicast data traffic transmitted to the first next next hop router for purposes of forwarding the multicast data traffic over the first backup path; and
appending a fourth switching label to the multicast data traffic transmitted to the second next next hop router for purposes of forwarding the multicast data traffic through the second backup path.

12. A method as in claim 1, wherein initiating transmission of the multicast data traffic over the at least one backup path includes initiating label-stacking techniques to forward the multicast data traffic over the at least one backup path.

13. A method as in claim 1, wherein configuring the network to include at least one backup path with respect to a primary network path includes utilizing a respective backup path used to route unicast data traffic on which to forward the multicast data traffic in response to detecting the failure.

14. A method as in claim 1 further comprising:
initiating a label checking routine at the second router in lieu of RPF (Reverse Path Forwarding) checking at the second router prior to forwarding the multicast data traffic to a next hop router, the label checking routine verifying whether the received multicast data traffic includes a label normally received at the second router.

15. A method as in claim 1 further comprising:
disabling RPF (Reverse Path Forwarding) checking at the second router in order to accept multicast data traffic received on a respective interface associated with the at least one backup path.

16. A method as in claim 1, wherein configuring the network to include at least one backup path with respect to a primary network path includes:
setting up a first backup path between the first router and the second router;
setting up a second backup path between the first router and a respective router to which the second router normally forwards the multicast data traffic that is received from the first router; and
selectively forwarding the multicast data traffic on one of the first backup path and the second path depending on whether the second router is an edge router in the network.

17. A computer system for implementing multicasting communication services in a label-switching network, the computer system comprising:
a processor;
a memory unit that stores instructions associated with an application executed by the processor; and
an interconnect coupling the processor and the memory unit, enabling the computer system to execute the application and perform operations of:
configuring the network to include at least one backup path with respect to a primary network path that supports multicast label switching of multicast data traffic;
transmitting the multicast data traffic from the computer system over the primary network path to a router; and
in response to detecting a failure in the network, initiating transmission of the multicast data traffic over the at least one backup path in lieu of transmitting the multicast data traffic over the primary network path.

18. A computer system as in claim 17, wherein transmitting the multicast data traffic over the primary network path includes appending a first switching label to the multicast data traffic, the first switching label identifying to which multicast communication session in the network the multicast data traffic pertains; and
wherein initiating transmission of the multicast data traffic over the at least one backup path includes appending the first switching label to the multicast data traffic as well as appending a second switching label to the multicast data traffic, the second switching label being used for label switching of the multicast data traffic through the at least one backup path in the network.

19. A computer system as in claim 17, wherein initiating transmission of the multicast data traffic over the at least one backup path includes transmitting the multicast data traffic as well as the first switching label and the second switching label over the at least one backup to a specific router in the network, the method further comprising:
removing the second switching label from the multicast data traffic prior to being received at the specific router such that the specific router receives the multicast data traffic and the first switching label without the second switching label.

20. A computer system as in claim 19, wherein initiating transmission of the multicast data traffic over the at least one backup path includes transmitting the multicast data traffic as well as the first switching label and the second switching label over a respective tunnel to the specific router, the second switching label being used to route the multicast data traffic through the respective tunnel to the second router.

21. A computer system as in claim 20, wherein detecting the failure in the network includes:
receiving information indicating that a link failure occurs in the primary network path between the first router and the second router;
in response to detecting the link failure, identifying the second router as a next hop to forward the multicast data traffic.

22. A computer system as in claim 21, wherein initiating transmission of the multicast data traffic over the at least one backup path includes:
selecting a pre-configured backup path, which is one of the at least one backup path, between the first router and second router for communicating the multicast data traffic in lieu of transmitting the multicast data traffic over the primary network path to the second router, the pre-configured backup path also being used to support rerouting of unicast data traffic.

23. A computer system as in claim 17, wherein detecting the failure in the network includes:
receiving information indicating that a node failure occurs at the second router;
in response to detecting the node failure, identifying a set of at least one router as a respective set of next next hop routers to which the second router would normally forward the multicast data traffic in an absence of the node failure.

24. A computer system as in claim 23, wherein initiating transmission of the multicast data traffic over the at least one backup path includes:
selecting multiple pre-configured backup paths from the at least one backup path between the first router and the set of at least one router in which to forward the multicast data traffic in lieu of transmitting the multicast data traffic over the primary network path to the second router.

25. A computer system as in claim 24, wherein initiating transmission of the multicast data traffic over the at least one backup path includes:
generating multicast data traffic at the first router to include a first switching label that the second router normally uses to route the multicast data traffic to a respective first next next hop router in lieu of generating the multicast data traffic to include a different label used to normally route the multicast data traffic from the first router to the second router; and
from the first router, transmitting the multicast data traffic including the first switching label to the respective first next next hop router over a first backup path.

26. A computer system as in claim 25, wherein initiating transmission of the multicast data traffic over the at least one backup path includes:
generating multicast data traffic at the first router to include a second switching label that the second router normally uses to route the multicast data traffic to a respective second next next hop router in lieu of generating the multicast data traffic to include another respective label used to normally route the multicast data traffic from the first router to the second router; and
from the first router, transmitting the multicast data traffic including the second switching label to the respective second next next hop router over a second backup path.

27. A computer system as in claim 26, wherein initiating transmission of the multicast data traffic over the at least one backup path includes:
appending a third switching label to the multicast data traffic transmitted to the first next next hop router for purposes of forwarding the multicast data traffic over the first backup path; and
appending a fourth switching label to the multicast data traffic transmitted to the second next next hop router for purposes of forwarding the multicast data traffic through the second backup path.

28. A computer system as in claim 17, wherein initiating transmission of the multicast data traffic over the at least one backup path includes initiating label-stacking techniques to forward the multicast data traffic over the at least one backup path.

29. A computer system as in claim 17, wherein configuring the network to include at least one backup path with respect to a primary network path includes utilizing a respective backup path used to route unicast data traffic on which to forward the multicast data traffic in response to detecting the failure.

30. A label-switching network system comprising:
a first data communication device;
a second data communication device; and
the first data communication device supporting operations of:
configuring the label-switching network to include at least one backup path with respect to a primary network path that supports multicast label switching of multicast data traffic;
transmitting the multicast data traffic from the first data communication device over the primary network path to the second data communication device; and
in response to detecting a failure in the label-switching network, initiating transmission of the multicast data traffic over the at least one backup path in lieu of transmitting the multicast data traffic over the primary network path;
the second data communication device supporting operations of:.
initiating a label checking routine at the second data communication device in lieu of RPF (Reverse Path Forwarding) checking at the second data communication device prior to forwarding the multicast data traffic to a next hop router, the label checking routine verifying whether the received multicast data traffic includes a label normally received at the second data communication device for data traffic received from the first data communication device.

31. A computer system for implementing multicasting services, the computer system including:
means for configuring the network to include at least one backup path with respect to a primary network path that supports multicast label switching of multicast data traffic;
means for transmitting the multicast data traffic from a first router over the primary network path to a second router; and
means for initiating transmission of the multicast data traffic over the at least one backup path in lieu of transmitting the multicast data traffic over the primary network path in response to detecting a failure in the network.

32. A computer program product including a computer-readable medium having instructions stored thereon for processing data information, such that the instructions, when carried out by a processing device, enable the processing device to perform the steps of:
configuring a label-switching network to include at least one backup path with respect to a primary network path that supports multicast label switching of multicast data traffic;
transmitting the multicast data traffic from a first router over the primary network path to a second router; and
in response to detecting a failure in the network, initiating transmission of the multicast data traffic over the at least one backup path in lieu of transmitting the multicast data traffic over the primary network path.
